(19) United States
(12) Patent Application Publication
(10) Pub. No.: US 2020/0000661 A1
(43) Pub. Date: Jan. 2, 2020

(54) A BED SYSTEM

(71) Applicant: GDV TECHNOLOGY APS, Viborg (DK)

(72) Inventor: Viorel CHICINAS, Viborg (DK)

(21) Appl. No.: 16/482,448

(22) PCT Filed: Jan. 29, 2018
(86) PCT No.: PCT/DK2018/050017

§ 371 Date: Jul. 31, 2019

(30) Foreign Application Priority Data
Feb. 1, 2017 (DK) PA 2017 70060

(51) Int. Cl. A61G 7/00; A61G 7/008; A61G 7/015; A61G 7/018

(52) U.S. Cl. CPC A61G 7/001; A61G 7/018; A61G 7/015; A61G 7/008

(57) ABSTRACT

There is provided a bed system that is simple to install on existing beds and which does not require any modification of the existing bed. The bed system has a base frame with attachment means for attachment of the bed system to an existing frame of a hospital bed. First and second sections with bed elements ensure proper support for the patient, and these sections are pivotally movable around an axis parallel with the length of the patient.

### FIELD OF THE INVENTION

This invention relates to a novel bed system having sections that can be moved in order to avoid bed sores.

### BACKGROUND OF THE INVENTION

Elderly and disabled people who spend long periods of time in bed are susceptible to bedsores. These people must be turned frequently in order to reduce the likelihood of bedsores. At present, health and safety regulations stipulate that three people must be used to turn the occupant of the bed. This is not efficient. In addition, large strains are placed on the back of the people turning the person over.

In addition, elderly, disabled people and people with motor control problems are at risk of falling out of bed, whether asleep or awake. This is a further problem in that the person may not be able to get back into the bed or even to raise an alarm. Barriers can be placed on the sides of the beds but these barriers may cause injury to the person or one of their limbs by striking the barriers.

A great number of disabled people find it impossible to either adjust their sleeping position or to arise from a prone position, i.e. at night when having retired to bed, without the help of another person which can be costly and inconvenient. In addition, the disabled person experiences a lack of independence.

It is of extreme importance that a disabled person has to be turned or to have their position adjusted at regular intervals to maintain good circulation, ease cramps and avoid bedsores, which can occur by remaining in one position for long periods.

Wheelchair users find it difficult to straighten their legs easily in bed. Frequently, disabled people or their helpers will place a pillow below their knees in order to raise their knees and to maintain the legs in a more comfortable slightly bent position. However, the pillow becomes more compact and the support provided reduces and, also, the pillow does not provide support across the full width of the bed. Furthermore, the pillow position may move and stable support is not provided.

U.S. Pat. No. 2,113,286 discloses a hospital bed where the frame and mattress are divided longitudinally and each section pivots 90 degrees from the horizontal. The hospital bed has guardrails and the pivotal movement is accomplished in a manual fashion. The bed is secured in an angular position through the use of support members resting in notches.

U.S. Pat. No. 3,230,554 discloses a motion regulator device to control the relative movement of objects. This device uses a motorized power screw to regulate relative motion in mechanical systems. The device relates specifically to the application of such devices to adjustable beds, chairs or sofas to regulate relative movement between various sections thereof.

U.S. Pat. No. 4,658,451 discloses a carrier for supporting a person in different postural positions. It contains a hydraulic drive means for pivoting the main rest area to allow the patient to be turned over, supported on their side or transferred.

EP1486191A1 discloses an adjustable bed system for turning a patient. The bed system includes a tilt mechanism adapted to tilt the platform surface laterally, a side member disposed on a side of the platform, a side-member lift mechanism adapted to raise the side member relative to the platform surface, and the tilt mechanism tilting the platform surface toward the side member raised by the side-member lift mechanism. Meanwhile, it does not include sliding means horizontally movable perpendicular to the central longitudinal axis of a hospital bed, when the bed system is attached to said hospital bed.

DK178222B B1 discloses a bed system to be installed on existing hospital beds. The bed system has a first and a second frame nested in a common pivot means, and actuators connected thereto in order to establish an angle formed between the frames, where they are rotatable about a longitudinal axis through activation of the actuators. Meanwhile, it does not involve first and second sections that are attached to the actuators in pivot points.

DK201670202A discloses a bed system, which can be installed in an existing hospital bed. The bed system comprises first and second sections, wherein said sections are pivotally movable around an axis parallel with the length of the patient. DK201670202A does not have a linking member for interconnecting each of the sections and a corresponding actuator, where the linking member comprises two pivot points at each endpoint to which the actuator is rotatable attached to one of the pivot points.

None of the above disclosures, taken either singly or in combination, is seen to describe the instant invention as claimed. There is a need for a simple bed system that can move specific body parts in order to avoid bed sores.

### SUMMARY OF THE INVENTION

According to a first aspect of the present invention there is provided a bed system for turning a patient comprising:
a frame (1) extending transversally relative to a longitudinal axis of the bed system;
first (2) and a second (3) sections having bed elements for supporting the patient, said first (2) and second (3) sections being pivotally movable around an axis parallel with the length of the bed system;
a first (4) and a second (5) linear actuator connected to said first (2) and second (3) sections thereby enabling movement of the sections, each of said first and second actuator (4, 5) being attached to the frame (1);
control unit for moving the first (2) and second (3) sections independently, whereby an angle formed between said first (2) and second (3) sections is controlled, said first (2) and second (3) sections being rotatable through activation of the first (4) and second (5) actuator;

wherein the first section (2) is attached to the frame in a first pivot point (P1), and the second section is attached to the base frame in a second pivot point (P2) enabling the sections to be rotatably moved,

wherein the first (4) and second (5) actuators are mounted on the on the frame (1) and pointing towards each other so that actuation is performed a single plane,

wherein the first section (2) is attached to the first actuator (4) via a linking member (6) having a pivot point (P3) in one end and another pivot point (P4) in the other end, whereby the first actuator (4) is rotatably attached to the pivot point (P3) and the first section (2) is rotatably attached to the pivot point (P4), and

wherein the second section (3) is attached to the second actuator (5) via a linking member (7) having a pivot point (P30) in one end and another pivot point (P40) in the other end, whereby the second actuator (5) is rotatably attached to the pivot point (P30) and the second section (3) is rotatably attached to the pivot point (P40).

In a preferred embodiment of the present invention actuation in a single plane is ensured by actuators having their actuation head, such as a piston in a pneumatic actuator, positioned in a linear track enabling the part of the actuation head (P3, P30) to slide in the single plane.

The pivot points P3 and P4 of the linking me member are preferably separated by 2-8 cm. This also applies to the pivot points P30 and P40 of the linking me member.

In a particularly preferred embodiment extension elements are rotatably attached to the first and second sections for longitudinally extending the support of the patient. These extension elements are preferably provided with hinges to ensure vertical movement. In agreement with FIG. 4 the upper surface of the extension elements is controlled by an actuator to maintain a constant angle relative to the frame while the angle of the first and second sections changes relative to the frame. In the specific embodiment shown in

FIG. 4 this is achieved by establishing four pivot points in a parallelogram-like configuration.

The bed elements for supporting the patient are preferably flat and quadratic to ensure even support. Moreover, the bed elements for supporting the patient may provided with joints to allow bending of the bed elements.

In a second aspect the present invention provides an integrated hospital bed comprising a hospital bed, and at least two bed systems of the present invention. In this way different body parts can be moved independently.

### BRIEF DESCRIPTION OF THE DRAWINGS

FIG. 1 is a perspective view of the bed system.

FIG. 2 is a view of the bed system that is intended to support the upper part of a human being.

FIG. 3 shows how the first and second sections are attached to the main frame and the actuators.

FIG. 4 shows how the upper surface of the extension elements is controlled by an actuator to maintain a constant angle relative to the frame.

### DETAILED DESCRIPTION OF THE INVENTION

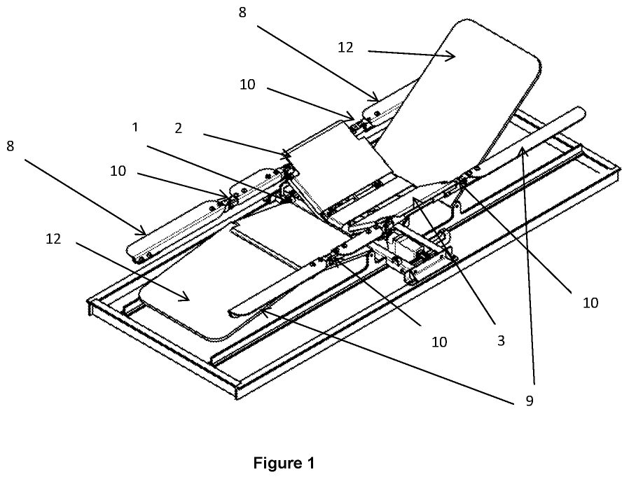

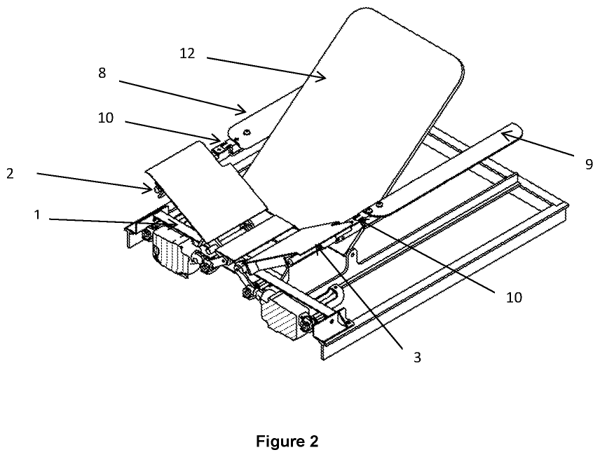

Referring to FIG. 1 there is shown a perspective view of the bed system that is ready to be attached to an existing bed for turning a patient in order to avoid pressure sores. There is shown a first and a second section having bed elements for supporting the patient. There is also shown extension elements extending along the length of the bed system. The first and second sections are pivotally movable around an axis. FIG. 2 shows the bed system that is intended to support the upper part of a human being.

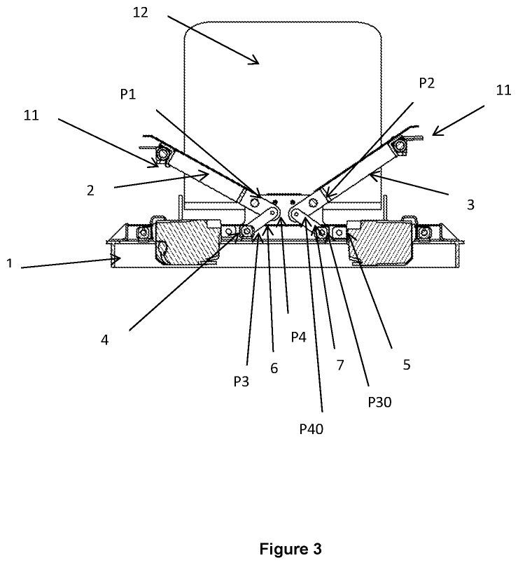

In FIG. 3 there is shown how the actuators and bed sections are pivotally connected. There is shown how the first section is attached to the base frame in a first pivot point (P1), and the second section is attached to the base frame in a second pivot point (P2) enabling the sections to be rotatably moved. There is also shown how the first and second actuators are mounted on the frame and pointing towards each other so that actuation is performed a single plane. This is achieved since the first section is attached to the first actuator via a linking member (6) having a pivot point (P3) in one end and another pivot point (P4) in the other end, whereby the first actuator is rotatably attached to the pivot point (P3) and the first section is rotatably attached to the pivot point (P4), and. Similarly the second section is attached to the second actuator via a linking member (7) having a pivot point (P30) in one end another pivot point (P40) in the other end, whereby the second actuator is rotatably attached to the pivot point (P30) and the second section is rotatably attached to the pivot point (P40).

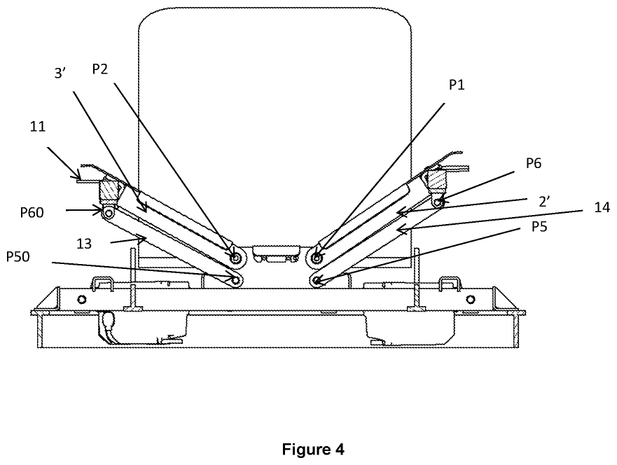

FIG. 4 shows how the upper surface of the extension elements is controlled to maintain a constant angle relative to the frame. The upper surface (11) of the extension elements (8, 9) is kept at a constant angle relative to the frame while the angle of the first and second sections changes relative to the frame. This is achieved by the parallelogram construction shown in FIG. 4. This construction is achieved through the members 3′ and 13 on one side of the bed system and the members 2′ and 14 on the other side. Importantly the member 13 is provided with the pivot points P50 and P60, the former being on the frame, whereas the latter links to the extension element (9), which is attached to the second (3) section in a hinge. Similarly, the member 14 is provided with the pivot points P5 and P6, the former being on the frame, whereas the latter links to the extension element (8), which is attached to the first (2) section in a hinge.

1. A bed system for turning a patient comprising:
a frame extending transversally relative to a longitudinal axis of the bed system;
first and a second sections having bed elements for supporting the patient, said first and second sections being pivotally movable around an axis parallel with the length of the bed system;
a first and a second linear actuator connected to said first and second sections thereby enabling movement of the sections, each of said first and second actuator being attached to the frame;
control unit for moving the first and second sections independently, whereby an angle formed between said first and second sections is controlled, said first and second sections being rotatable through activation of the first and second actuator;
wherein the first section is attached to the frame in a first pivot point, and the second section is attached to the base frame in a second pivot point enabling the sections to be rotatably moved,
wherein the first and second actuators are mounted on the on the frame and pointing towards each other so that actuation is performed a single plane,
wherein the first section is attached to the first actuator via a linking member having a pivot point in one end and another pivot point in the other end, whereby the first actuator is rotatably attached to the pivot point and the first section is rotatably attached to the pivot point, and
the second section is attached to the second actuator via a linking member having a pivot point in one end and another pivot point in the other end, whereby the second actuator is rotatably attached to the pivot point and the second section is rotatably attached to the pivot point.

2. A bed system according to claim 1, wherein actuation in a single plane is ensured by actuators having their actuation head, such as a piston in a pneumatic actuator, positioned in a linear track enabling the part of the actuation head slide in the single plane.

3. A bed system according to claim 1, wherein the pivot points of the linking member are separated by 2-8 cm.

4. A bed system according to claim 1, wherein the pivot points of the linking me member are separated by 2-8 cm.

5. A bed system according to claim 1, wherein the bed elements for supporting the patient are flat and quadratic to ensure even support.

6. A bed system according to claim 1, wherein extension elements are rotatably attached to the first and second sections for longitudinally extending the support of the patient.

7. A bed system according to claim 6, wherein the extension elements are provided with hinges to ensure vertical movement.

8. A bed system according to claim 6, wherein the upper surface of the extension elements is controlled by an actuator to maintain a constant angle relative to the frame while the angle of the first and second sections changes relative to the frame.

9. A bed system according to claim 1, wherein a base frame is provided below the frame, and wherein the system further includes moveable support elements for supporting the patient in the areas not supported by the first and second sections.

10. An integrated bed, such as a hospital bed, comprising:
a bed frame; and
at least one bed system according to claim 1.
